(19) United States
(12) Patent Application Publication
(10) Pub. No.: US 2014/0190900 A1
(43) Pub. Date: Jul. 10, 2014

(54) APPARATUS FOR SEPARATING FLUIDS AND ASSOCIATED METHODS

(71) Applicant: Kenneth Roderick Stewart, Blairs (GB)

(72) Inventor: Kenneth Roderick Stewart, Blairs (GB)

(73) Assignee: Rotech Group Limited, Aberdeen, Aberdeenshire (GB)

(21) Appl. No.: 14/127,717

(22) PCT Filed: Jun. 22, 2012
(86) PCT No.: PCT/GB2012/051456

§ 371 Date: Mar. 11, 2014

(30) Foreign Application Priority Data
Jun. 25, 2011 (GB) 1110855.2

(51) Int. Cl. E02B 15/04; C02F 1/38

(52) U.S. Cl. CPC E02B 15/04; C02F 1/38
USPC 210/739; 210/170.11; 210/747.5; 210/512.1; 210/787; 210/96.1

(57) ABSTRACT

An apparatus for treating contaminated water and may include an inlet, configured to receive contaminated water from a body of water. The contaminated water may include one or more pollutants (such as oil), and the apparatus may be configured to provide for separating those pollutant(s) from water to provide recovered pollutant(s) (e.g. recovered oil) and treated water. The apparatus may also include a water outlet for returning treated water to a body of water. In some examples, the apparatus comprises a separation volume, having inner and outer chamber, which can be used to separate rotating contaminated water.

### TECHNICAL FIELD

This invention relates to apparatus for separating fluids, and associated methods. In particular, the invention relates to apparatus for separating pollutants (e.g. oil) from water, and associated apparatus and methods. In some examples, the apparatus is an underwater or subsea tool.

### BACKGROUND

Oil spillage into the sea is an unfortunate occurrence. Methods for recovery include the use of absorbent materials such as rope or mats which soak up the oil and release the oil under applied pressure, and systems which seek to skim the oil from the surface of the water.

However, such methods are slow, making the recovery process expensive and increasing the risk of spillages resulting in severe environmental impact. Therefore, there is a need for quickly recovering oil from a spill site, while not recovering too much seawater in the process, which would otherwise make the storage and later treatment and separation of the oil/water mix expensive and problematic.

Herein by “underwater” is meant below or under a surface of a body of water, whether moving or static, natural or man-made, e.g. a sea, ocean, river, canal, lake, loch, dam, or the like. However, the invention may find particular use in seas or oceans.

### SUMMARY

According to a first aspect of the invention there is provided underwater apparatus for treating contaminated water, the apparatus comprising an inlet configured to receive contaminated water from a body of water, such contaminated water comprising water and one or more pollutants, and wherein the apparatus is configured to provide for separating pollutant(s) from water to provide recovered pollutant(s) and treated water, wherein the apparatus comprises a water outlet for returning treated water to a body of water.

The apparatus may be configured to provide for separating one or more hydrocarbon pollutant substances from water. The apparatus may be configured to separate oil pollutants from water.

The apparatus may comprise a pollutant outlet for providing recovered pollutant(s) to further apparatus. The apparatus may be configured to retain, or store, recovered pollutant(s). Treated water may comprise some pollutant(s). Recovered pollutant(s) may comprise some water.

The water outlet may be for returning treated water to a body of water via a further apparatus.

The body of water may be a sea, ocean, loch, lake, estuary, forth, sound. The apparatus may be configured to be substantially underwater (e.g. partially submerged). The apparatus may be configured to be fully underwater (e.g. fully submerged). The apparatus may be considered to be a subsea apparatus. The apparatus may be configured for use at a particular distance below the surface of water (e.g. 1 meter, 2 meters, 3 meters, etc.), for example, when being towed from a vessel. The apparatus may be configured to float at a particular distance below the surface of water (e.g. 1 meter, 2 meters, 3 meters, etc.). The apparatus may be configured for variable buoyancy.

The apparatus may be configured such that the inlet is surface facing, or substantially surface facing, in use. For example, the apparatus may be configured such that the inlet faces a surface of contaminated water, wherein pollutant rests upon the water (i.e. surface of the water).

The apparatus may comprise a separation volume for separating pollutant(s) and water from contaminated water, the separation volume being in communication with the inlet. The apparatus may be configured so as to impart a rotation on contaminated water, for example, such that contaminated water rotates within the separation volume. The apparatus may be configured to impart a rotation at the inlet. The inlet may comprise one or more inlet guides, configured to impart a rotation.

The pollutant(s) outlet may be associated with a central region of the separation volume. The water outlet may be associated with an outer region of the separation volume. The separation volume may comprise a first and a second separation chamber, the second chamber configured within the first chamber.

The apparatus may be configured such that pollutant(s) in contaminated water are urged towards the inner separation chamber. The separation volume may comprise a constricted region. The constriction region may be provided between the outer chamber and the inner chamber, such that fluid is urged to the inner chamber.

The apparatus may comprise one or more channels connecting the outer separation chamber with the inner separation chamber. The apparatus may be configured such that the channel(s) impart a rotation on fluid moving from the outer chamber to the inner chamber (e.g. a further rotation). The channel(s) may be configured to tangentially connect outer and inner chambers.

The outer separation chamber may be in communication with the water outlet, e.g. direct communication. The outer separation chamber may comprise the water outlet. The inner chamber may be in communication with the pollutant outlet. The inner chamber may comprise the pollutant outlet. The pollutant outlet may be configured to impart a rotation on fluid within the inner separation chamber (e.g. further rotation). The pollutant outlet may be configured to remove fluid tangentially, e.g. to the intended rotation of fluid within the inner separation chamber in order to impart rotation.

The inner separation chamber may be in communication with the water outlet. An outer region of the inner separation chamber may provide one or more outlet channels, the outlet channel(s) in communication with the water outlet.

The apparatus may be configured such that the outer separation chamber is configured to provide a first separation of pollutant(s) and water, and the inner separation chamber is configured to provide a second separation of pollutant(s) and water.

The apparatus may comprise an inlet pump, configured to draw contaminated water into the apparatus. The inlet pump may comprise an impeller. The apparatus may comprise a water outlet pump. The water outlet pump may be configured to pump treated water from the apparatus. The apparatus may comprise a suction pump, configured to draw contaminated water into the apparatus and to pump treated water from the apparatus. The suction pump may be in communication with the inlet and the water outlet in order to draw fluid through the apparatus (e.g. from the inlet to the outlet, via the separation volume). The suction pump may be provided at the water outlet of the apparatus. The suction pump may be provided at a fluid inlet of the apparatus.

The apparatus may comprise an inlet pump (e.g. the suction pump) at a fluid inlet, configured to additionally impart a particular rotation to fluid being pumped into the apparatus. The imparted rotation may be a complementary rotation, in that the rotation imparted is consistent with the direction of rotation provided by one, some or all different elements (e.g. vanes and/or pumps) within the apparatus.

The suction pump may comprise one or more impellers (e.g. two impellers). The suction pump may be a centrifugal design, axial design, or mixed flow design. The pump may be configured to for suction and rotation (e.g. minimising fluid mixing). In such cases, the pump may be configured as a mixed flow design. The pump may be configured for separation (e.g. to provide a greater pressure for the separation process). In such cases, the pump may be configured as a mixed flow design, or centrifugal design.

The apparatus may be configured to cause a treated water mass flow of fluid at a pressure of roughly 7 to 14.5 pounds per square inch (e.g. roughly 0.5 to 1 Bar). The apparatus may be configured to cause a treated water mass flow at a volume rate of around 0.5 to 2.5 m³/s. The suction pump may be configured as a mass flow pump, or mass flow means. The suction pump may be configured to cause a mass flow of fluid at a pressure of roughly 7 to 14.5 pounds per square inch (e.g. roughly 0.5 to 1 Bar). The suction pump may be configured to cause a mass flow at a volume rate of around 0.5 to 2.5 m³/s. The suction pump may be configured to cause a mass flow of fluid at a pressure of roughly up to 5 Bar (e.g. when the suction pump is provided at the inlet to the apparatus).

The apparatus may be configured to draw in up to roughly 1,000 litres of contaminated water per second. The apparatus may be configured to draw in up to roughly 15,000 gallons of contaminated water per minute.

The suction pump may comprise two or more rotors (e.g. impellers). The suction pump may be configured such that rotors contra-rotate.

The apparatus may comprise a pollutant extraction pump. The pollutant extraction pump may be in communication with the pollutant outlet in order to remove pollutant(s) from the apparatus. The pollutant extraction pump may be provided at the pollutant outlet.

The apparatus may be configured to cause a flow of fluid at a pressure of roughly 7 to 14.5 pounds per square inch (e.g. roughly 0.5 to 1 Bar) at the pollutant outlet. The apparatus may be configured to cause a volume rate of fluid of around 0.1 to 0.25 m³/s at the pollutant outlet. The extraction pump may be configured to cause a flow of fluid at a pressure of roughly 7 to 14.5 pounds per square inch (e.g. roughly 0.5 to 1 Bar). The extraction pump may be configured to cause a volume rate of around 0.5 to 2.5 m³/s.

The apparatus may be configured such that the volume flow rate is variable of one or more of: contaminated water volume flow rate; treated water volume flow rate; and recovered pollutant volume flow rate. The apparatus may be configured to vary the volume flow rate of the suction pump and/or the extraction pump in order to vary one or more of: contaminated water volume flow rate; treated water volume flow rate; and recovered pollutant volume flow rate.

The apparatus may be configured to determine the amount of water compared to the amount of pollutant in contaminated water entering the apparatus (e.g. the water-cut of contaminated water, ratio of water to pollutant, etc.). The apparatus may be configured to determine the conductivity (e.g. electrical conductivity) of contaminated water entering the apparatus in order to determine the amount of water compared to the amount of pollutant.

For different water/pollutant ratios, the apparatus may be configured to vary one or more of: contaminated water volume flow rate; treated water volume flow rate; and recovered pollutant volume flow rate. The apparatus may be configured to use a determined water/pollutant ratio in order to vary one or more of: contaminated water volume flow rate; treated water volume flow rate; and recovered pollutant volume flow rate. The apparatus may be configured to dynamically vary one or more of: contaminated water volume flow rate; treated water volume flow rate; and recovered pollutant volume flow rate.

The pollutant outlet may be configured at an upper region of the apparatus. The upper region may comprise the inlet. The water outlet may be configured at a lower region of the apparatus. The water outlet may be configured below the inlet to the apparatus.

According to a second aspect of the invention there is provided apparatus for separating fluids, the apparatus comprising an inlet configured to received at least a first and second fluid from a fluid source and configured to provide for separating first and second fluids, wherein the apparatus further comprises a first outlet and a second outlet, the first outlet for providing a separated first fluid for storage with the apparatus and/or to a further apparatus, and the second outlet for returning a separated second fluid to a fluid source.

The apparatus may comprise any of the features of the first aspect.

According to a third aspect of the invention there is provided apparatus for separating fluids, the apparatus comprising an inlet for receiving first and second fluids from a fluid source, such a second fluid being denser than a first fluid, wherein the inlet is in communication with a separation volume comprising an inner separation chamber and an outer separation chamber, and wherein the apparatus is configured such that a first fluid rotating in the separation volume is urged to the inner separation chamber and a second fluid is urged to the outer separation chamber.

The apparatus may be configured to draw in cumulatively up to roughly 1,000 litres of first and second fluid per second. The apparatus may be configured to draw in cumulatively up to roughly 15,000 gallons of first and second fluid per minute.

The fluids may be of differing densities. The first fluid may be a pollutant, or effluent. The first fluid may be oil. The second fluid may be water, such as salt water, or fresh water. The first and second fluids may be immiscible.

The apparatus may be configured such that a first outlet is for providing a substantially separated first fluid to further apparatus. A second outlet may be for returning substantiality separated second fluid to a fluid source. In other words, the apparatus may be configured such that the fluid at the first outlet is substantially a first fluid, while fluid at the second outlet is substantially a second fluid. The first outlet may be associated with the inner separation volume. The second outlet may be associated with the outer separation volume.

The apparatus may be configured for use in a body of water (e.g. a sea). The apparatus may be configured to be buoyant in a body of water (e.g. at a particular depth). The apparatus may be configured such that the inlet is surface facing, or substantially surface facing, in use. For example, the apparatus may be configured such that the inlet faces a surface of a fluid source comprising water and oil, wherein the oil rests upon of the water.

The apparatus may comprise one or more channels connecting the outer separation chamber with the inner separation chamber. The apparatus may be configured such that the channel(s) impart a rotation on fluid moving from the outer chamber to the inner chamber (e.g. a further rotation). The channel(s) may be configured to tangentially connect outer an inner chambers.

According to a fourth aspect of the invention there is provided apparatus for treating contaminated water, the apparatus comprising an inlet configured to receive contaminated water from a body of water, such contaminated water comprising water and one or more pollutants, and wherein the apparatus is configured to provide for separating pollutant(s) from water to provide recovered pollutant(s) and treated water, wherein the apparatus comprises a water outlet for returning treated water to a body of water.

The apparatus may comprise any of the features of the first aspect.

According to a fifth aspect of the invention there is provided apparatus for providing for separating fluids, the apparatus comprising:
an inlet configured to receive a combined fluid comprising at least a first and second fluid;
a first outlet for providing a separated first fluid; and
a second outlet for providing a separated second fluid; and wherein
the apparatus is configured to vary the volume flow rate of one or more of: a combined fluid at the inlet; a separated first fluid phase at the first outlet, or a separated second fluid phase at the second outlet, based upon the amount of a first fluid with respect to the amount of a second fluid in a combined fluid.

According to a sixth aspect of the invention there is provided a method for treating contaminated water, the method comprising:
receiving contaminated water from a body of water, such contaminated water comprising water and one or more pollutants;
separating underwater the pollutant(s) from the water to provide recovered pollutant(s) and treated water; and
returning the treated water to the body of water.

The method may comprising separating one or more hydrocarbon pollutant substances from water. The method may comprise separating oil pollutants from water.

The step of returning treated water to the body of water may mean that the contaminated/treated water is not taken to a vessel, or the like, for treatment/separation.

Separating underwater may comprise using an underwater apparatus, or subsea apparatus, to separate the pollutants from water.

The method may comprise providing (e.g. from a body of water) recovered pollutant(s) to further apparatus.

The body of water, may be a sea, ocean, loch, lake, estuary, forth, sound. The method may comprise separating fluids at a particular distance below the surface of the water (e.g. 1 meter, 2 meters, 3 meters, etc.).

The method may comprise draw in up to roughly 1,000 litres of contaminated water per second. The method may comprise to draw in up to roughly 15,000 gallons of contaminated water per minute.

The method may comprise varying the volume flow rate of one or more of the contaminated water, treated water, or pollutant, based on the amount of pollutant compared to water.

According to a seventh aspect of the invention there is a method for separating fluids, the method comprising:
receiving at least a first and second fluid from a fluid source, such first and second fluids for separating;
separating underwater the first fluid from the second fluid; and
returning one of the first and second fluid to fluid source.

According to an eighth aspect a method for separating fluids, the method comprising:
receiving first and second fluids from a fluid source, such a second fluid being denser than a first fluid,
communicating first and second fluid to a separation volume comprising an inner separation chamber and an outer separation chamber, and
rotating the fluids in the separation volume such that the first fluid is urged to the inner separation chamber and a second fluid is urged to the outer separation chamber.

The rotating of the fluids may be provided when receiving the first and second fluid.

According to a ninth aspect of the invention, there is provided a method for providing for separating fluids, the method comprising:
receiving, at an inlet, a combined fluid at a particular inlet volume low rate, the combined fluid comprising at least a first and second fluid;
outletting a separated first fluid at a particular first outlet volume flow rate; and
outletting a separated second fluid at a particular second outlet volume flow rate; and wherein
the method comprises varying or selecting the volume flow rate of one or more of: inlet volume low rate; first outlet volume flow rate, or second outlet volume flow rate, based upon the amount of first fluid with respect to the amount of second fluid in the combined fluid.

The method may comprise varying or selecting the volume flow rate of the inlet volume low rate and the first outlet volume flow rate based upon the amount of first fluid with respect to the amount of second fluid in the combined fluid.

According to a tenth aspect of the invention there is provided underwater means for treating contaminated water, the means for treating comprising an means for receiving contaminated water from a body of water, such contaminated water comprising water and one or more pollutants, and wherein the means for treating is configured to provide for separating pollutant(s) from water to provide recovered pollutant(s) and treated water, wherein the means for treating comprises a means for returning treated water to a body of water.

The invention includes one or more corresponding aspects, embodiments or features in isolation or in various combinations whether or not specifically stated (including claimed) in that combination or in isolation. For example, it will readily be appreciated that features recited as optional with respect to the first aspect may be additionally applicable with respect to any of second aspect, etc., without the need to explicitly and unnecessarily list those various combinations and permutations here. Corresponding means for performing one or more of the discussed functions are also within the present disclosure.

It will be appreciated that one or more embodiments/aspects may be useful treating contaminated water. Such embodiments/aspects may allow for oil, or the like, to be removed and/or recovered from contaminated water.

The above summary is intended to be merely exemplary and non-limiting.

### BRIEF DESCRIPTION OF THE FIGURES

Embodiments of the invention will now be described by way of example only, and with reference to the accompanying drawings, which are:

FIG. 1 a cross-section view of apparatus;

FIG. 2 a top view in cross-section of chambers/channels of the apparatus of FIG. 1 showing the flow path from outer separation chamber to inner separation chamber;

FIG. 3 a top view in cross-section of the apparatus of FIG. 1 showing a channel for extracting a desired fluid phase;

FIG. 4a various configurations of inner separation chamber of apparatus;

FIG. 5 a cross-section view of the apparatus of FIG. 1 illustrating the fluid flow path through the apparatus; and

FIG. 6 a cross-section view of the underwater oil spill recovery apparatus of FIG. 1 illustrating conical first and second separation chambers and illustrating the removal and easy access to the separation chambers to facilitate cleaning, etc.

### DETAILED DESCRIPTION OF THE FIGURES

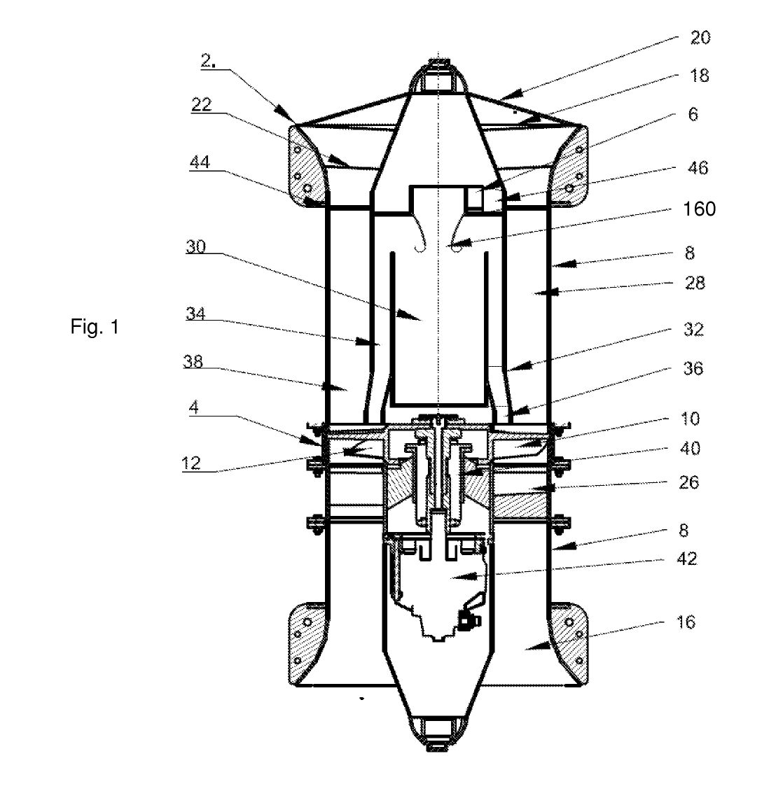

Referring firstly to FIG. 1, there is illustrated apparatus 2, or tool, according to an embodiment of the invention. Here, the apparatus 2 is configured for treating water that has been contaminated with a pollutant, and in particular hydrocarbon substances, such as oil. In this example, the apparatus will be described as configured to provide for separating oil and water. However, it will readily be appreciated that the apparatus may be used to separate alternative pollutants from water (e.g. alternative effluents or discharges).

Here, the apparatus 2 is configured for use underwater, or subsea, and comprises a hollow body with at least one means for drawing in contaminated water to be processed. The means for drawing in contaminated water is provided by a suction pump 4, which in this example is shown as a mass flow means 4. A skilled reader will appreciate that a mass flow means operates by directing a flow of high volume fluid under low pressure (e.g. mass flow excavators may be used at a sea bed or at a subsea structure or surface to displace material such as sea bed material). This is in contradistinction to “jet” type apparatus which direct a flow of low volume fluid under high pressure at the sea bed. “Mass flow” and “jet” or “jetting” are therefore distinct terms.

The suction pump 4 comprises a housing 8 and at least one impeller 10 or rotor provided within the housing 8, which impeller 10 comprises a plurality of blades 12. In some examples, the suction pump 4 comprises two or more impellers, which may be configured so as to contra-rotate.

The apparatus 2 further comprises means for separating the fluids phases, which in this example is shown as a separation volume comprising an outer separation chamber 30 and an inner separation chamber 28. The apparatus further comprises a water extraction pump 4 and an oil extraction pump 6 for extracting the fluid phases and/or desired fluid phases from the total volume of liquid. In this example, the suction pump 4 additionally functions as the water extraction pump.

The oil extraction pump may be another pump means such as a propeller, centrifugal or other means. Here, the suction pump 4 is positioned after the separation volume. Of course, in some examples, the suction pump 4 may be positioned before the separation volume, for example, for mechanically breaking up the fluid phases for processing. In some examples, the pump 4 may be provided at the fluid inlet of the apparatus 2.

In some examples, the pump 4 may also be configured to impart a particular rotation to fluid being pumped through the apparatus. The imparted rotation may be a complementary rotation, in that the direction of rotation imparted is consistent with the direction of rotation provided by one, some or all different elements (e.g. vanes and/or pumps) within the apparatus.

The apparatus 2 is configured so as to be deployed in the body of water such that the suction pump 2 draws the liquid vertically downwards into the apparatus 2 and into the outer separation chamber 30 (the first cylindrical channel or chamber) within the apparatus. The inlet 20 of the apparatus 2 comprises one or more guide vanes 22 for directing the flow of liquid around the first cylindrical channel at a predetermined angle. For example, for a first cylindrical channel with an outer diameter of 840 mm and inner diameter of 420 mm, guide vanes 22 may be set at around 6 degrees at the outer diameter and 13 degrees at the inner diameter. Here, the guide vanes 22 are configured to impart a rotation on fluid (e.g. contaminated water) entering the apparatus, and thus fluid in the separation volume.

In use, fluid being drawn into the tool may be at a volume of, for example, 1,000 litres per second. The fluid directed around the outer separation volume will be subjected to a centrifugal force, determined by the speed of rotation of fluid around the chamber. From consideration of the relative densities of the various phases of the liquid the rate of separation of the phases may be determined, or determinable.

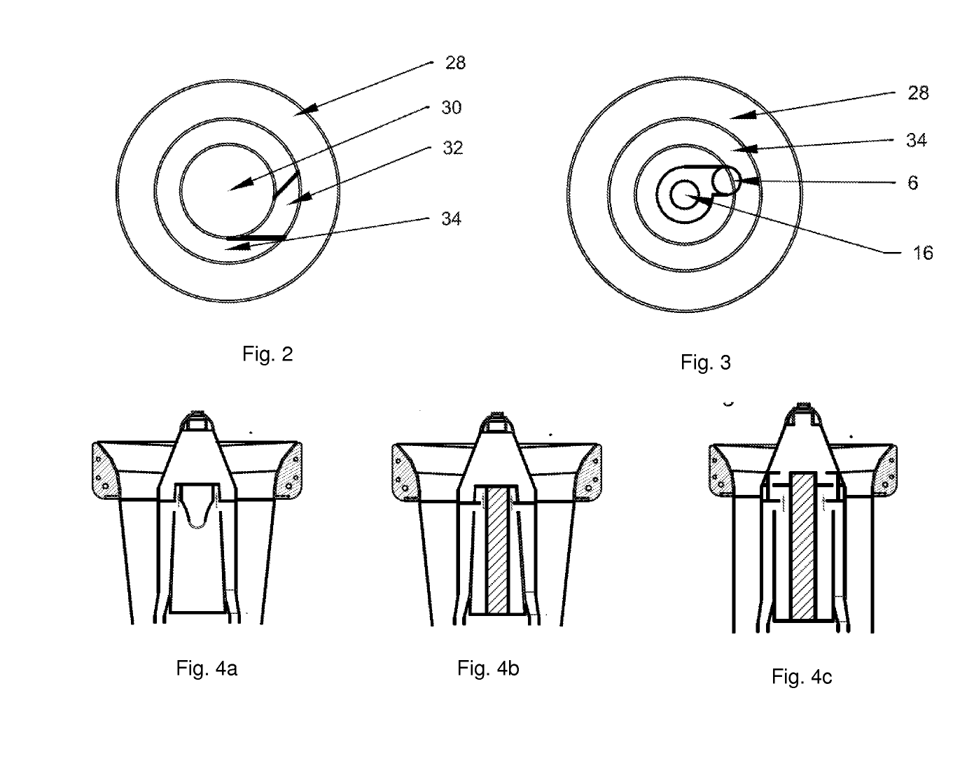

The apparatus 2 is configured such that heavier/denser fluids move to an outer diameter of the outer separation volume and lighter fluids move towards an inner diameter. The lighter fluids are then withdrawn via a channel 32. A cross-section of the apparatus 2 at indicted at 32 on FIG. 1 is shown as FIG. 2.

As can be seen, the channel 32 (or port downstream) is provided in an inner wall of the outer separation chamber 28. Extracted fluid, (e.g. oil) may, at that stage, be recovered to a storage container onboard a surface vessel or it may be processed through the inner separation chamber 30. In this example, the inner separation chamber 30 is provided within the apparatus 2, however, in further examples, the inner separation chamber 30 may be provided distinct from the apparatus 2.

To provide further rotation, and thus separation, within the inner separation chamber 30, the inlet channel 32 is positioned tangential to the secondary chamber 30. As such fluid is sucked into the secondary chamber via an inlet channel, the configuration of the channel imparts a further rotation. The rotation of the fluid within the secondary separation chamber 30 causes heavier fluid to move to the outside of the chamber 30 and the lighter fluid to move towards the centre of the chamber 30. In addition, the apparatus 2 comprises a restriction region 38 provided between the outer separation chamber and the inner separation chamber. The restriction region causes a region of increased pressure, which further serves to urge fluid from the outer separation chamber to the inner separation chamber.

As rotating liquid moves through the inner separation chamber 30 it approaches the oil outlet, and thus the extraction pump. Lighter fluid (e.g. oil) can be withdrawn from a centre region of the inner separation chamber. The remaining fluid is exhausted from the apparatus 2 through exhaust channels 34. To encourage flow through the exhaust channels 34, the outlet of the exhaust channels 34 is positioned such that they form part of the inlet flow channel for the suction device 4. Alternatively a separate suction means may be used.

FIG. 3 shows a cross-section of the apparatus at the oil outlet, in which oil is tangentially removed from the inner separation chamber 30, in a similar manner to the channel of FIG. 2. In other words, the extraction pump 6 has a suction outlet which is tangential to its centre to further encourage rotation of the fluid. The suction outlet may be substantially frusto-conical in shape. The suction outlet may form a venturi which may further accelerate the rotation of the fluid and encourage a vortex effect in front of the inlet to further aid rotation and separation of the fluid phases. This further adds to the rotation of the fluid in the inner separation chamber.

In some examples, the oil outlet (and/or extraction pump) is configured such that oil is suctioned further towards the outer diameter of the inner separation chamber. FIG. 4a shows a guiding cone leading the oil in the centre towards suction channels at a larger diameter. FIG. 4b shows a core in the centre configured to reduce the effective internal diameter of the inner separation chamber 30. Such a configuration may allow for increasing the effective rotation speed, and thus the separation, of the fluid in the inner separation chamber 30. FIG. 4c shows a further example comprising a weir configuration to help separate the oil.

In some examples, the extraction pump 6 may be used together with one or more valves (e.g. one or more variable/controllable valve), which can be used to control and/or further assist with the extraction of oil, or the like, from the apparatus 2. The valve(s) (not shown for clarity) may be positioned prior to the extraction pump 6, or after the extraction pump 6 (e.g. in an inline manner). It will be appreciated that using such valves may increase the ability with which the apparatus 2 can be used to control the flow rate of the extracted oil (or the like).

It will be appreciated that the inner and/or outer separation chambers may be substantially cylindrical/elongated in shape; frusto-conical in shape; inverted frusto-conical in shape. In this example, the inner separation chamber is substantially concentric with the outer separation chamber.

The characteristics of the apparatus (and the potential to separate the various fluid phases) may be varied by one or more of: increasing chamber diameters; reducing passage diameters to increase speed of rotation; increasing length of chambers.

In alternative embodiments, the apparatus may be configured such that one or both of the inner and outer chambers rotate to introduce rotation of the fluid. This may be provided by skin friction, or may be assisted by the use of paddles within the chambers. It will also be understood that separation of the fluid phases may be further assisted with the use of weirs within the chambers.

In use, the apparatus is deployed in a marine environment from a vessel (not shown) e.g. by a crane or tugger wire to maintain and or/adjust position of the apparatus. The apparatus 2 is deployed so as to be completely submerged just below the surface of the water. In such an environment the volume of the various fluid phases and the percentage of oil spill to seawater being ingested into the apparatus 2 cannot be easily regulated or controlled. While the liquid volume being ingested may be controlled by the suction pump 2, in order to extract the desired liquid phase in an efficient manner, it may, in some embodiments, be helpful to the separation process that the percentage of the desired liquid phase to be extracted from the total liquid flow is known.

Therefore, in some embodiments, that apparatus comprises means for measuring water-cut of contaminated water entering the apparatus 2 (e.g. by measuring the conductivity at a plurality of measuring points to determine the instantaneous conductivity of the flow).

It will be understood that the conductivity of the flow will change with the percentage of oil in the liquid flow. Alternative methods may be used to measure the mix of liquid phases, including conductive and/or resistivity sensors, such as use of two opposing electrode sensors or the use of inductive conductivity sensors.

With known conductivity reference points for fluid one, e.g. seawater, and for fluid two e.g. crude oil, and for mixes of fluids one and two, it is possible to calibrate the output of the sensing devices via a control module (computing device) which can then be used to supply signals to control devices which control the suction pump 4 and the extraction pump 6 for the desired fluid phase (i.e. for the amount of oil to be removed).

In this example, the suction pump and extraction pump are both driven by motors, such as hydraulic motors, which are supplied with power via independently controlled variable-swash hydraulic pumps. The output from the control module is used to control the position of the hydraulic swash and thereby control the supply of power to the suction pump and extraction pump. Alternatively, it will be understood that the suction pump and/or extraction pump may be driven with variable displacement hydraulic motors, which may utilise variable swash controls.

When the liquid (i.e. contaminated water) being ingested into the tool is 100% water (e.g. seawater) then up to 100% of the power would be directed to the suction pump and 0% to the extraction pump. If the liquid being ingested is 100% oil then up to 100% of the power would be directed to the extraction pump.

In use, the suction pump 4 operates at or causes a mass flow of fluid/water/oil at a pressure of around 7 to 14.5 psi (0.5 to 1 Bar). The suction pump 4 operates at or causes the mass flow at a volume rate of around 0.5 to 2.5 m³/s.

In use, the extraction pump 6 operates at or causes a flow of fluid/oil phase at a pressure of around 7 to 14.5 psi (0.5 to 1 Bar). The extraction pump 6 operates at or causes a flow of fluid/oil phase at a volume rate of around 0.1 to 0.25 m³/s.

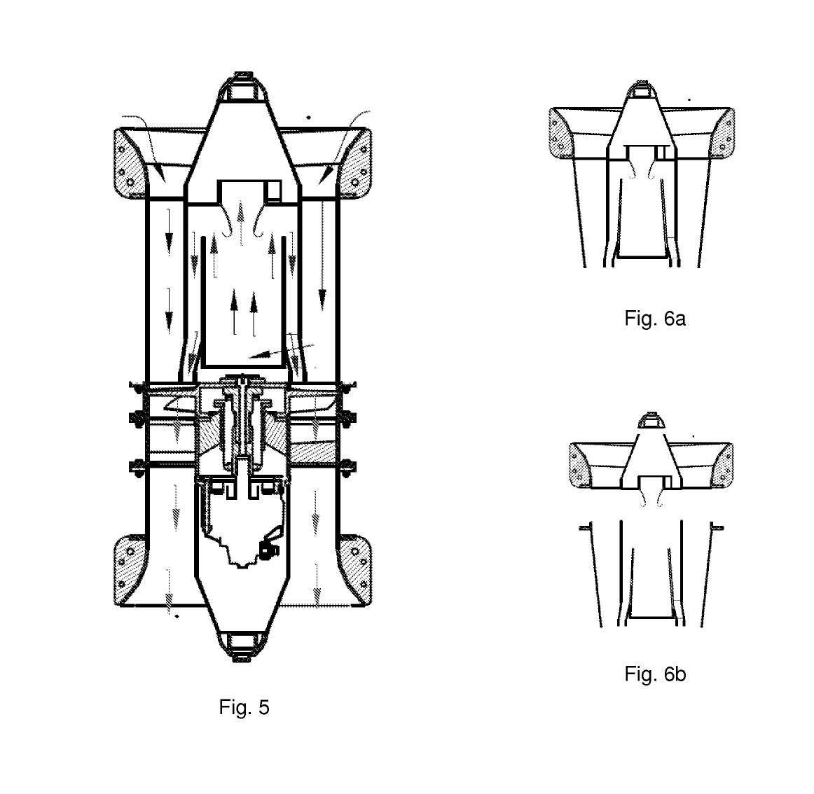

FIG. 5 shows an exemplary flow of fluid through the apparatus 2.

The apparatus 2 is shown with an inlet 18 and an outlet which taper or flare outwardly, e.g. in a trumpet-like shape. The inlet 18 of the apparatus 2 is disposed to face in substantially the same direction as the outlet 18 of the suction pump 4. In addition, the inlet 18 is configured to face the surface of the water. The outlet 18, on the other hand, 4 is configured so as to face substantially downwardly, in use.

The inlet 18 of the apparatus 2 is disposed such that contaminated water or fluid is drawn substantially downwardly, in use. The inlet 18 of the apparatus 2 is provided with a filter 20 to prevent ingress of large seaborne debris.

As discussed, inlet guide vanes 22 are provided within the inlet 18 and may also be located in housing 8 to guide the mass flow of fluid around outer separation chamber or channel 24, in use. Guide vanes 26 are provided between the impeller 10 and the outlet 16.

The outlet 16 is removably connectable to the apparatus 2, as is shown in FIG. 6a. This allows for replacement, e.g. if damaged, or exchanged with another outlet (not shown) of different size and/or shape. In this way characteristics, e.g. pressure and/or flow rate, of the suction pump 6 can be controlled and/or preselected, e.g. dependent upon whether it is desired to agitate the fluid exiting the apparatus 2 to aid dispersal of the fluid or material. In a similar manner, FIG. 6b shows the apparatus 2 in which the inlet 18 is removable to allow for ease of cleaning, and/or replacement/configuration of the separation volume (i.e. inner and outer separation chambers).

As mentioned, the apparatus 2 comprises a separation volume for separating fluids, which may be considered to act like a centrifugal separator, which in this example comprises an outer separation chamber 28 and an inner separation chamber 30. In use, as fluid is drawn into the apparatus 2 by the suction pump 4 the fluid is caused to rotate by inlet guide vanes 22. As the fluid is caused to rotate denser fluid is forced towards the outer diameter of outer separation chamber 28 and fluids of lighter phase are forced towards the inner diameter of the outer separation chamber 28. Fluid of the lighter phase is then drawn through the channel(s) 32 into to the inner separation chamber 30.

In this particular embodiment, fluid is induced, or urged, or additionally urged, to enter the inner separation chamber 30 by the narrowing of fluid flow channel 38 in first separation chamber 28. This causes a region of localised higher pressure. The narrowing is provided by the positioning of the exhaust channels 36 in the flow stream of the outer separation chamber.

In some examples, only a single channel 32 is used between inner and outer chamber. This may help avoid mixing of streams of fluid phases separated in first separation chamber 18.

It will readily be appreciated that in a further embodiment of the apparatus the rotation and thus separation of the fluid may be caused by the placement of the suction pump 4 at the inlet 18 of the apparatus 2.

Furthermore, the pump (e.g. at the inlet) may be configured to additionally impart a particular rotation to fluid being pumped into the apparatus. The imparted rotation may be a complementary rotation, in that the rotation imparted is consistent with the direction of rotation provided by one, some or all different elements (e.g. vanes and/or pumps) within the apparatus.

It will also be readily appreciated that the suction pump may be a centrifugal design, axial design, or mixed flow design. In cases where the pump is configured to provide assist with suction and rotation (e.g. so as to minimise fluid mixing), the pump can be configured as a mixed flow design. Whereas, in cases where the pump is to be configured to assist with separation (e.g. to provide a greater pressure for the separation process), then the pump is configured as a mixed flow design, or centrifugal design. A skilled reader will readily be able to implement these embodiments.

Additionally or alternatively, paddles placed in the inner and/or outer second separation chambers 28 and 30 may be used. Additionally or alternatively, either or both chambers may rotate. This mechanical rotation could be achieved, for example, by attaching the paddles or chambers to the mass flow rotor 10 supported by bearings 40 and driven by hydraulic motor 42. It will be appreciated that an electric motor could also be used.

In a further embodiment, the apparatus may be deployed in multiple units used in parallel to process additional volumes of fluid or may be used in series to further refine the recovery of a desired phase of fluid. In other words, the oil and/or treated water output of one apparatus may be the input of a further apparatus.

Means for measuring the constituency of the fluid 44 e.g. oil in water content, such as by measuring the relative density with the use of capacitive or resistive sensors, lasers or acoustics may be positioned within the inlet 18, and/or within either or both separation chambers 28 and 30.

The output from sensors 44 can then be supplied to a control module (not shown) which then provides output control signals to the power supply units for hydraulic motor 42 and suction pump 6 to control the rate of flow into the apparatus 2 and the rate of extraction of the desired phase via extraction pump 16.

As mentioned, in some examples, the extraction rate for the desired phase may be controlled, e.g. if the desired phase extraction shows a high percentage of water, to reduce the flow by partly closing proportional valve or nozzle 46.

It will be appreciated that the embodiments of the invention hereinbefore described are given by way of example only, and are not meant to be limiting the scope of the invention in any way.

1. Underwater apparatus for treating contaminated water, the apparatus comprising an inlet configured to receive contaminated water from a body of water, such contaminated water comprising water and one or more pollutants, and wherein the apparatus is configured to provide for separating pollutant(s) from water to provide recovered pollutant(s) and treated water, wherein the apparatus comprises a water outlet for returning treated water to a body of water.

2. Apparatus according to claim 1 comprising a pollutant outlet for providing recovered pollutant(s) to further apparatus.

3. Apparatus according to claim 1 wherein the apparatus is configured to be substantially underwater at a particular distance below the surface of water and/or the apparatus is configured for variable buoyancy.

4. Apparatus according to claim 1 wherein the inlet is substantially surface facing in use.

5. Apparatus according to claim 1 comprising a separation volume for separating pollutant(s) and water from contaminated water, the separation volume being in communication with the inlet.

6. Apparatus according to claim 5 configured so as to impart a rotation on contaminated water such that contaminated water rotates within the separation volume, such as by using one or more vanes at the inlet.

7. Apparatus according to claim 1 wherein the separation volume comprises an inner and an outer separation chamber, the inner separation chamber configured within the outer chamber.

8. Apparatus according to claim 7 wherein the separation volume comprises a constricted region provided between the outer separation chamber and the inner separation chamber such that fluid is urged towards the inner chamber.

9. Apparatus according to claim 7 comprising one or more channels connecting the outer separation chamber with the inner separation chamber, whereby the channel(s) are configured to impart a rotation on fluid moving from the outer chamber to the inner chamber.

10. Apparatus according to 5 wherein the outer separation chamber comprises the water outlet.

11. Apparatus according to 5 when depending upon claim 2, wherein the inner separation chamber comprises the pollutant outlet.

12. Apparatus according to claim 11 wherein the pollutant outlet is configured to impart a rotation on fluid within the inner separation chamber by being configured to remove fluid tangentially from the inner separation chamber.

13. Apparatus according to claim 1 comprising a suction pump, configured to draw contaminated water into the apparatus and to pump treated water from the apparatus.

14. Apparatus according to claim 13 wherein the suction pump is provided at the water outlet of the apparatus.

15. Apparatus according to claim 13 wherein the suction pump is configured as a mass flow pump, or mass flow means.

16. Apparatus according to claim 1 configured to draw in up to roughly 1,000 litres of contaminated water per second.

17. Apparatus according to claim 1 comprising a pollutant extraction pump configured to remove pollutant(s) from the apparatus.

18. Apparatus according to claim 1 configured such that a volume flow rate is variable of one or more of: contaminated water volume flow rate; treated water volume flow rate; and recovered pollutant volume flow rate.

19. Apparatus according to claim 18 configured to determine a ratio of water to pollutant in contaminated water entering the apparatus and to vary one or more of: contaminated water volume flow rate; treated water volume flow rate; and recovered pollutant volume flow rate using a determined water/pollutant ratio.

20. Apparatus according to claim 1 wherein the water outlet is configured at a lower region of the apparatus, such as being configured below the inlet of the apparatus.

21. Apparatus according to claim 1 configured to provide for separating one or more hydrocarbon pollutant substances from water.

22. A method for treating contaminated water, the method comprising:
receiving contaminated water from a body of water, such contaminated water comprising water and one or more pollutants;
separating underwater the pollutant(s) from the water to provide recovered pollutant(s) and treated water; and
returning the treated water to the body of water.

23. The method according to claim 22 comprising separating one or more hydrocarbon pollutant substances from water.

24. The method according to claim 22 wherein the step of returning treated water to the body of water means that the contaminated/treated water is not taken to a vessel, or the like, for separation.

25. The method according to claim 22 comprising providing recovered pollutant(s) to further apparatus.

26. Apparatus for separating fluids, the apparatus comprising an inlet for receiving first and second fluids from a fluid source, such a second fluid being denser than a first fluid, wherein the inlet is in communication with a separation volume comprising an inner separation chamber and an outer separation chamber, and wherein the apparatus is configured such that a first fluid rotating in the separation volume is urged to the inner separation chamber and a second fluid is urged to the outer separation chamber.

27. Apparatus according to claim 26 configured to draw in cumulatively up to roughly 1,000 litres of first and second fluid per second.

28. Apparatus according to claim 26 comprising a first outlet for providing a substantially separated first fluid to further apparatus and a second outlet for returning substantiality separated second fluid to a fluid source.

29. Apparatus according to claim 28 wherein the first outlet is associated with the inner separation volume and the second outlet is associated with the outer separation volume.

30. Apparatus according to claim 26 comprising one or more channels connecting the outer separation chamber with the inner separation chamber, the channel(s) configured to impart a rotation on fluid moving from the outer chamber to the inner chamber.

31. Apparatus according to claim 26 configured for use in a body of water.

32. Apparatus according to claim 31 wherein the inlet is substantially surface facing in use.

33. Apparatus according to claim 26 wherein the first fluid is a pollutant, or effluent, and the second fluid is water.

34. A method for separating fluids, the method comprising
receiving first and second fluids from a fluid source, the second fluid being denser than the first fluid,
communicating first and second fluids to a separation volume comprising an inner separation chamber and an outer separation chamber, and
rotating the fluids in the separation volume such that the first fluid is urged to the inner separation chamber and the second fluid is urged to the outer separation chamber.

35. Apparatus for providing for separating fluids, the apparatus comprising:
an inlet configured to receive a combined fluid comprising at least a first and second fluid;
a first outlet for providing a separated first fluid; and
a second outlet for providing a separated second fluid; and wherein
the apparatus is configured to vary the volume flow rate of one or more of: a combined fluid at the inlet; a separated first fluid phase at the first outlet, or a separated second fluid phase at the second outlet, based upon the amount of a first fluid with respect to the amount of a second fluid in a combined fluid.

36. A method for providing for separating fluids, the method comprising:
receiving, at an inlet, a combined fluid at a particular inlet volume low rate, the combined fluid comprising at least a first and second fluid;
outletting a separated first fluid at a particular first outlet volume flow rate; and
outletting a separated second fluid at a particular second outlet volume flow rate; and wherein
the method comprises vary the volume flow rate of one or more of: inlet volume low rate; first outlet volume flow rate, or second outlet volume flow rate, based upon the amount of first fluid with respect to the amount of second fluid in the combined fluid.

37. The method according to claim 36 comprising vary the volume flow rate of the inlet volume low rate and the first outlet volume flow rate based upon the amount of first fluid with respect to the amount of second fluid in the combined fluid.
